(19) United States
(12) Patent Application Publication
(10) Pub. No.: US 2026/0134857 A1
(43) Pub. Date: May 14, 2026

(54) SOUND TRANSMISSION METHOD AND COMMUNICATION DEVICE THEREOF

(71) Applicant: BENQ CORPORATION, Taipei City (TW)

(72) Inventor: Chen-Chen Tsai, Taipei City (TW)

(73) Assignee: BENQ CORPORATION, Taipei City (TW)

(21) Appl. No.: 19/186,654

(22) Filed: Apr. 23, 2025

(30) Foreign Application Priority Data
Nov. 8, 2024 (TW) 113142828

(51) Int. Cl. G10H 1/00

(52) U.S. Cl. CPC G10H 1/0041; G10H 1/0025; G10H 2210/051; G10H 2210/066; G10H 2210/086

(57) ABSTRACT

A sound transmission method is applied to a communication device and includes utilizing an operation processor of the communication device to decompose an audio signal into at least one audio track having a specific sound element, utilizing the operation processor to transform the at least one audio track into a symbolic text, and utilizing a transceiver of the communication device to transmit the symbolic text.

### BACKGROUND OF THE INVENTION

### 1. Field of the Invention

The present invention relates to a sound transmission method and a communication device, and more particularly, to a sound transmission method of converting an audio track into a reconstructed symbol and a related communication device.

### 2. Description of the Prior Art

A conventional online conference system converts the analog sound into the digital audio, and then transmits the digital audio to other computer; audio in specific bands of the digital audio is filtered out by the foresaid other computer to suppress environmental noise. However, the conventional online conference system directly converts the analog sound into the digital audio without adjusting the volume, so that the volume of different sound sources are inconsistent when the digital audio is played on the foresaid other computer, and the post-production effect is unavailable. In addition, the conventional online conference system is worse in correcting the echo cancellation and the sound delay, and is prone to feedback because of the close distance between the microphone and the speaker. Therefore, design of a sound transmission method and a communication device that can effectively correct the echo cancellation and the sound delay and prevent the feedback phenomenon is an important issue in the current communication industry.

### SUMMARY OF THE INVENTION

The present invention provides a sound transmission method of converting an audio track into a reconstructed symbol and a related communication device for solving above drawbacks.

According to the claimed invention, a sound transmission method is applied to a communication device. The sound transmission method includes an operation processor of the communication device decomposing an audio signal into at least one audio track having a specific sound element, the operation processor transforming the at least one audio track into a symbolic text, and the operation processor utilizing a transceiver of the communication device to transmit the symbolic text.

According to the claimed invention, a communication device includes a transceiver, a receiving module and an operation processor. The receiving module is adapted to receive an audio signal. The operation processor is electrically connected with the transceiver and the receiving module. The operation processor is adapted to decompose an audio signal into at least one audio track having a specific sound element, transform the at least one audio track into a symbolic text, and utilize the transceiver to transmit the symbolic text.

The sound transmission method of the present invention includes the sound receiving process and the sound playing process; the communication device can simultaneously execute the sound receiving process and the sound playing process of the sound transmission method, or can only execute the sound receiving process or the sound playing process of the sound transmission method by equipping with other external device. The communication device and the sound transmission method of the present invention can convert the audio signal into the symbolic text and optionally transmit it out through encryption or compression, and then a receiver (such as the communication device or the external device) can create and play the restore audio track in accordance with the symbolic text and its voiceprint after decryption or decompression, rather than directly transmitting and playing the existing audio track. The coordinate information and the change information contained by the audio signal can be transmitted and restored along with the symbolic text. Therefore, the communication device and the sound transmission method of the present invention can not only prevent the feedback, but also provide mixing adjustment for various sound processing programs, and has the excellent correction effect on echo cancellation and sound delay.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communication device according to an embodiment of the present invention.

FIG. 2 is a flow chart of a sound transmission method according to the embodiment of the present invention.

FIG. 3 is a flow chart of the sound transmission method according to another embodiment of the present invention.

### DETAILED DESCRIPTION

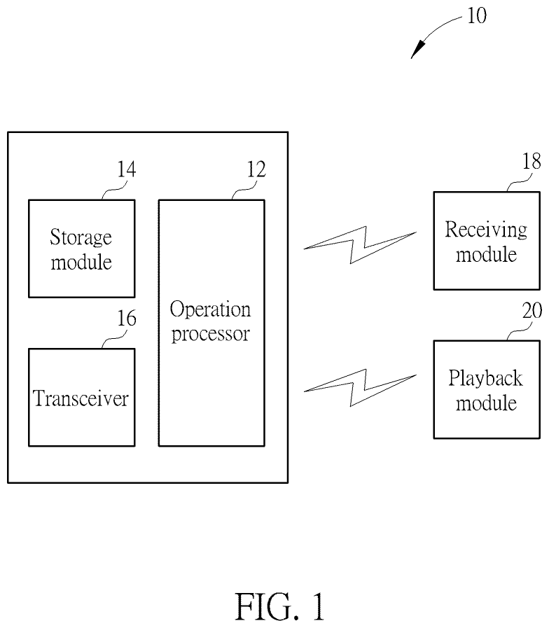

Please refer to FIG. 1. FIG. 1 is a functional block diagram of a communication device 10 according to an embodiment of the present invention. The communication device 10 can include an operation processor 12, a storage module 14, a transceiver 16, a receiving module 18 and a playback module 20. The operation processor 12 can be electrically connected with the storage module 14 and the transceiver 16, and can be set as a controller, a processor and any possible electronic component. The receiving module 18 can be a microphone. The playback module 20 can be a loudspeaker or an earphone. The receiving module 18 and the playback module 20 can be inner components of the communication device 10 and electrically connected with the operation processor 12 in a wired manner, or can be outer components of the communication device 10 and electrically connected with the operation processor 12 in a wireless manner. Application of the receiving module 18 and the playback module 20 is not limited to the foresaid embodiment, and depends on a design demand.

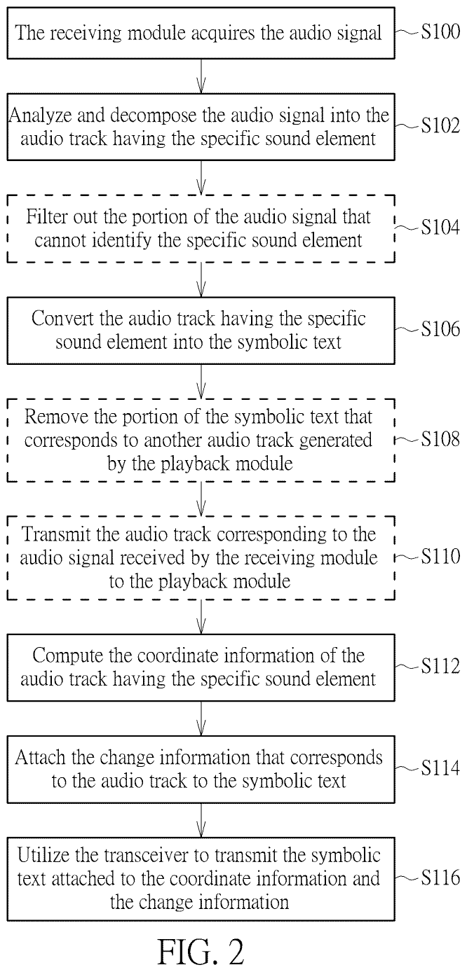

Please refer to FIG. 2. FIG. 2 is a flow chart of a sound transmission method according to the embodiment of the present invention. The sound transmission method illustrated in FIG. 2 can be suitable for the communication device 10 shown in FIG. 1. First, step S100 and step S102 can be executed that the receiving module 18 acquires an audio signal of the surrounding environment, and the operation processor 12 analyzes the audio signal to decompose the audio signal into an audio track having a specific sound element. In step S102, the sound transmission method can preferably decompose the audio signal into a recognizable sound and an unrecognizable sound. The recognizable sound can be a human voice, a piano sound, or any similar sound that can be represented by a symbol. The unrecognizable sound can be usually considered as background noise, such as the sound of running water, animal calls, wind or rain that cannot be represented by symbols. The recognizable sound can be a main sound source transmitted by the communication device 10, which can be defined as the audio track with the specific sound element. Therefore, the sound transmission method can identify the specific sound element from the audio signal in accordance with built-in information of the storage module 14 for creating the audio track.

Then, step S104 can be optionally executed that the operation processor 12 can filter out a portion of the audio signal that cannot identify the specific sound element; that is to say, the specific sound element (which means the human voice, the piano sound, or similar sound that can be represented by the symbol) cannot be identified from the unrecognizable sound. The communication device 10 may directly remove the unrecognizable sound, or may store the unrecognizable sound into the storage module 14 but not apply the unrecognizable sound for following steps of the sound transmission method. The present invention can also use other sound analysis method to analyze the unrecognizable sound, and apply an analysis result of the unrecognizable sound for an available audio track or represent it as the recognizable sound, or convert the analysis result of the unrecognizable sound into a specific symbol by other means; application of the sound analysis method is not limited to the foresaid embodiment, and depends on the design demand.

Then, step S106 can be executed that the operation processor 12 can convert the audio track having the specific sound element decomposed in step S102 into a symbolic text. The present invention can define that the symbolic text is selected from a group consisting of a phonetic symbol, a musical symbol, a feature symbol, and a combination thereof. The phonetic symbol can include, but not be limited to, a code symbol, a phonetic notation, a mandarin font and a foreign letter. The code symbol may be Morse code, or other common communication code. The mandarin font may be pronounced using the phonetic notation or the foreign letter (such as Romanization). The foreign letter may be any European or Asian language. The phonetic notation and the foreign letter can cover various known phonetic methods. The musical symbol can include, but not be limited to, a note, a rest, a flat and sharp sign, and a stave; any of the various characters that represent modern music notation can belong to a design scope of the present invention. The feature symbol can include, but not be limited to, a voiceprint symbol, a tone symbol and an intonation symbol. The voices of different creatures may have unique voiceprint symbols. The tone symbol may be the four tones in musicology. The intonation symbol may include stress, falling intonation, rising intonation, tempo, and/or volume.

Then, step S108 can be executed that the operation processor 12 can remove the portion of the symbolic text that corresponds to another audio track generated by the loudspeaker (which means the playback module 20). In step S108, the operation processor 12 is electrically connected with the playback module 20 and can acquire the audio signal and the audio track generated by the playback module 20. The sound transmission method can find out and then remove the portion of the symbolic text that corresponds to the audio track generated by the playback module 20 from the symbolic text converted in step S106, so as to avoid the sound output by the playback module 20 from being received and then played by the receiving module 18, thereby effectively avoiding the feedback phenomenon.

In addition, step S110 can be executed that the operation processor 12 can transmit the audio track corresponding to the audio signal received by the receiving module 18 to the earphone (which means the playback module 20). In step S110, if the communication device 10 is simultaneously connected with the microphone (which means the receiving module 18) and the earphone (which means the playback module 20), the sound transmission method can preferably transmit the sound of the microphone (which means the receiving module 18) back to the earphone (which means the playback module 20), for forming a side tone and providing auditory feedback. In the present invention, step S108 and step S110 can be optional steps of the sound transmission method, and the communication device 10 can determine whether to execute the anti-feedback step and/or the auditory feedback step in accordance with a configuration result of the sound playback module 20 (e.g., theloudspeaker or the earphone).

After that, step S112 can be executed that the operation processor 12 can compute coordinate information of the audio track having the specific sound element decomposed by each receiving module 18 when the communication device 10 includes a plurality of receiving modules 18, and attach the coordinate information to the symbolic text converted from the audio track. The coordinate information can be one-dimensional coordinate information, two-dimensional coordinate information or three-dimensional coordinate information, and used to indicate positional relation or related information of the receiving module 18 relative to the communication device 10 in space. Besides, step S114 can be executed that the operation processor 12 can attach change information that corresponds to the audio track to the symbolic text; the change information may be interpreted as volume, tempo, voice change effect, and/or other sound adjustment information provided by the communication device 10. Final, step S116 can be executed to utilize the transceiver 16 to transmit the symbolic text that is attached to the coordinate information and the change information.

For example, the communication device 10 can be used in a conference scenario, where the coordinate information of each receiving module 18 can be acquired in step S112, and the coordinate information can be attached to the symbolic text converted from each audio track; when the playback module 20 is used to read the symbolic text, the present invention can adjust the volume of the corresponding audio track in accordance with the coordinate information, and/or simulate and create frequency change and three-dimensional effect of sound playback. Moreover, the sound transmission method of the present invention can optionally attach a time code to the symbolic text or execute other sound processing programs, so that subsequent applications can achieve the effect of audio and video synchronization; as described in step S114, the volume, the beat, the voice change effect, and/or other change information can be regarded as the sound processing programs, and related variation depends on the design demand.

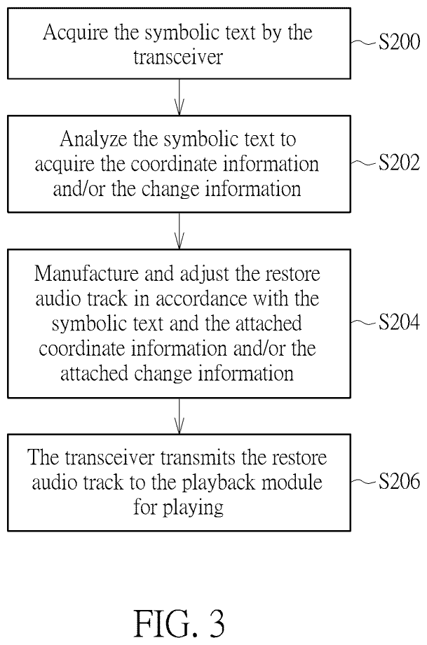

Please refer to FIG. 3. FIG. 3 is a flow chart of the sound transmission method according to another embodiment of the present invention. The sound transmission method illustrated in FIG. 2 can be suitable for the communication device 10 shown in FIG. 1. Step S110 to step S116 illustrated in FIG. 2 can be defined as a sound receiving process of the sound transmission method, and steps illustrated in FIG. 3 can be defined as sound playing process of the sound transmission method. First, step S200 and step S202 can be executed to acquire the symbolic text by the transceiver 16, and analyze the symbolic text to acquire the coordinate information and/or the change information. In step S200, the sound transmission method may acquire the symbolic text made by the communication device 10, or the symbolic text transmitted from an external device; the variation can depend on whether the communication device 10 is equipped with other external device. Then, step S204 and step S206 can be executed that the operation processor 12 can manufacture and adjust a restore audio track in accordance with the symbolic text and the attached coordinate information and/or the attached change information, and utilize the transceiver 16 to transmit the restore audio track to the playback module 20; or it can be interpreted that the playback module 20 can play the restore audio track based on the symbolic text. In step S206, the sound transmission method can transmit the restore audio track to the playback module 20 of the communication device 10 by the transceiver 16, or can transmit the restore audio track to the playback module of the external device; related variation can depend on whether the communication device 10 is equipped with other external device.

In conclusion, the sound transmission method of the present invention includes the sound receiving process and the sound playing process; the communication device can simultaneously execute the sound receiving process and the sound playing process of the sound transmission method, or can only execute the sound receiving process or the sound playing process of the sound transmission method by equipping with other external device. The communication device and the sound transmission method of the present invention can convert the audio signal into the symbolic text and optionally transmit it out through encryption or compression, and then a receiver (such as the communication device or the external device) can create and play the restore audio track in accordance with the symbolic text and its voiceprint after decryption or decompression, rather than directly transmitting and playing the existing audio track. The coordinate information and the change information contained by the audio signal can be transmitted and restored along with the symbolic text. Therefore, the communication device and the sound transmission method of the present invention can not only prevent the feedback, but also provide mixing adjustment for various sound processing programs, and has the excellent correction effect on echo cancellation and sound delay.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sound transmission method applied to a communication device, the sound transmission method comprising:
an operation processor of the communication device decomposing an audio signal into at least one audio track having a specific sound element;
the operation processor transforming the at least one audio track into a symbolic text; and
the operation processor utilizing a transceiver of the communication device to transmit the symbolic text.

2. The sound transmission method of claim 1, wherein the symbolic text is selected from a group consisting of a phonetic symbol, a musical symbol, a feature symbol, and a combination thereof, the phonetic symbol comprises a code symbol, a phonetic notation, a mandarin font and a foreign letter, the musical symbol comprises a note, a rest, a flat and sharp sign, and a stave, the feature symbol comprises a voiceprint symbol, a tone symbol and an intonation symbol.

3. The sound transmission method of claim 1, further comprising:
the operation processor removing a portion of the symbolic text that corresponds to another audio track generated by a playback module of the communication device.

4. The sound transmission method of claim 1, further comprising:
the operation processor transmitting the at least one audio track of the audio signal acquired by a receiving module of the communication device to a playback module of the communication device.

5. The sound transmission method of claim 1, further comprising:
the operation processor computing coordinate information of the at least one audio track; and
the operation processor attaching the coordinate information to the symbolic text.

6. The sound transmission method of claim 1, further comprising:
the operation processor attaching change information that corresponds to the at least one audio track to the symbolic text.

7. The sound transmission method of claim 1, further comprising:
the operation processor receiving the symbolic text by the transceiver;
the operation processor generating a restore audio track based on the symbolic text; and
the operation processor utilizing the transceiver to transmit the restore audio track to a playback module of the communication device.

8. The sound transmission method of claim 7, further comprising:
the operation processor acquiring coordinate information and/or change information that corresponds to the symbolic text; and
the operation processor adjusting the restore audio track in accordance with the coordinate information and/or the change information.

9. The sound transmission method of claim 1, further comprising:
the operation processor identifying the specific sound element from the audio signal in accordance with built-in information of a storage module of the communication device for creating the at least one audio track.

10. The sound transmission method of claim 9, further comprising:
the operation processor filtering out a portion of the audio signal that cannot identify the specific sound element.

11. A communication device comprising:
a transceiver;
a receiving module adapted to receive an audio signal; and
an operation processor electrically connected with the transceiver and the receiving module, the operation processor being adapted to decompose an audio signal into at least one audio track having a specific sound element, transform the at least one audio track into a symbolic text, and utilize the transceiver to transmit the symbolic text.

12. The communication device of claim 11, wherein the symbolic text is selected from a group consisting of a phonetic symbol, a musical symbol, a feature symbol, and a combination thereof, the phonetic symbol comprises a code symbol, a phonetic notation, a mandarin font and a foreign letter, the musical symbol comprises a note, a rest, a flat and sharp sign, and a stave, the feature symbol comprises a voiceprint symbol, a tone symbol and an intonation symbol.

13. The communication device of claim 11, wherein the operation processor is adapted to further remove a portion of the symbolic text that corresponds to another audio track generated by a playback module of the communication device.

14. The communication device of claim 11, wherein the operation processor is adapted to further transmit the at least one audio track of the audio signal acquired by a receiving module of the communication device to a playback module of the communication device.

15. The communication device of claim 11, wherein the operation processor is adapted to further compute coordinate information of the at least one audio track, and attach the coordinate information to the symbolic text.

16. The communication device of claim 11, wherein the operation processor is adapted to further attach change information that corresponds to the at least one audio track to the symbolic text.

17. The communication device of claim 11, wherein the operation processor is adapted to further receive the symbolic text by the transceiver, generate a restore audio track based on the symbolic text, and utilize the transceiver to transmit the restore audio track to a playback module of the communication device.

18. The communication device of claim 17, wherein the operation processor is adapted to further acquire coordinate information and/or change information that corresponds to the symbolic text, and adjust the restore audio track in accordance with the coordinate information and/or the change information.

19. The communication device of claim 11, wherein the operation processor is adapted to further identify the specific sound element from the audio signal in accordance with built-in information of a storage module of the communication device for creating the at least one audio track.

20. The communication device of claim 19, wherein the operation processor is adapted to further filter out a portion of the audio signal that cannot identify the specific sound element.
